(19) United States
(12) Patent Application Publication
(10) Pub. No.: US 2017/0044964 A1
(43) Pub. Date: Feb. 16, 2017

(54) FASTENING STRUCTURE

(71) Applicant: AUDI AG, Ingolstadt (DE)

(72) Inventor: WERNER WILDING, Walting (DE)

(73) Assignee: AUDI AG, Ingolstadt (DE)

(21) Appl. No.: 15/235,269

(22) Filed: Aug. 12, 2016

(30) Foreign Application Priority Data
Aug. 13, 2015 (DE) 102015010513.2

(51) Int. Cl. F01N 13/18; B62D 65/16

(52) U.S. Cl. CPC F01N 13/1805; B62D 65/16

(57) ABSTRACT

A fastening structure for securing a component of an exhaust system to a body of a motor vehicle includes a bracket which is secured to the component of the exhaust system. The bracket includes a recess and at least one receiving opening. A bearing element is secured to the body and configured for attachment to the bracket. The bearing element includes a fastening pin which is received in the recess of the bracket. A safety device is configured for attachment to the bracket. The safety device includes a receiving hole for passage of the fastening pin of the bearing element, and at least one mechanical stop element configured for arrangement in the receiving opening of the bracket.

### CROSS-REFERENCES TO RELATED APPLICATIONS

This application claims the priority of German Patent Application, Serial No. 10 2015 010 513.2, filed Aug. 13, 2015, pursuant to 35 U.S.C. 119(a)-(d), the disclosure of which is incorporated herein by reference in its entirety as if fully set forth herein.

### BACKGROUND OF THE INVENTION

The present invention relates to a fastening structure for securing a component of an exhaust system to a body of a motor vehicle.

The following discussion of related art is provided to assist the reader in understanding the advantages of the invention, and is not to be construed as an admission that this related art is prior art to this invention.

An exhaust system of a motor vehicle has several components, such as exhaust pipe and muffler via which exhaust gas produced by an internal combustion engine of the motor vehicle is discharged. At least one component of the exhaust system is hereby mechanically connected to the motor vehicle.

It would be desirable and advantageous to provide an improved fastening structure to obviate prior art shortcomings.

### SUMMARY OF THE INVENTION

According to one aspect of the present invention, a fastening structure for securing a component of an exhaust system to a body of a motor vehicle includes a bracket secured to the component of the exhaust system, the bracket including a recess and at least one receiving opening, a bearing element secured to the body and configured for attachment to the bracket, the bearing element including a fastening pin received in the recess of the bracket, and a safety device configured for attachment to the bracket, the safety device including a receiving hole for passage of the fastening pin of the bearing element, and at least one mechanical stop element configured for arrangement in the receiving opening of the bracket.

According to another advantageous feature of the present invention, the bracket can include a base plate and two legs extending in parallel relationship, with the base plate extending between the legs in perpendicular relation thereto and connected to each of the legs via a bend, with the recess being configured in the form of a triangular slot or triangular notch formed in the base plate.

According to another advantageous feature of the present invention, the bearing element may be made of elastically deformable material.

According to another advantageous feature of the present invention, the safety device can be configured in the form of a plate which is curved at the bend by 90° and includes two rectangular portions connected to one another by the bend, the receiving hole being formed in one of the portions, and the at least one mechanical stop element being arranged at an end of the other one of the portions.

According to another advantageous feature of the present invention, the safety device can include two mechanical stop elements arranged at an edge of the other one of the two portions and oriented in opposite directions in parallel relation to the bend.

According to another advantageous feature of the present invention, the bracket can have two receiving openings arranged in the legs of the bracket, respectively. Such a receiving opening may be configured as notch or slot.

According to another advantageous feature of the present invention, the two mechanical stop elements can be arranged in the receiving openings of the legs, respectively.

According to another advantageous feature of the present invention, the safety device can be configured in the form of a flat disk, with the receiving hole being arranged in midsection of the disk. The safety device can include two mechanical stop elements which are arranged at an outer edge of the disk and oriented in opposite directions.

According to another advantageous feature of the present invention, the receiving opening, e.g. a slot or notch, can be formed in the bend between the base plate and the leg.

According to another advantageous feature of the present invention, the safety device can be configured for rotation about the fastening pin, after the fastening pin has been guided through the receiving hole and the safety device has been arranged on a base plate of the bracket, so as to turn the mechanical stop elements in the two receiving openings of the bracket, respectively, and to arrange, e.g. snap, the mechanical stop elements in the two receiving openings of the bracket.

After placement of the safety device upon the fastening pin, a nut can be threadably engaged upon the fastening pin so as to clamp the safety device between the nut and the bracket.

According to another aspect of the present invention, an exhaust system includes a component, and a fastening structure configured to secure the component to a body of a motor vehicle, the fastening structure including a bracket secured to the component and having a recess and at least one receiving opening, a bearing element secured to the body and configured for attachment to the bracket, the bearing element including a fastening pin received in the recess of the bracket, and a safety device configured for attachment to the bracket, the safety device including a receiving hole for passage of the fastening pin of the bearing element, and at least one mechanical stop element configured for arrangement in the receiving opening of the bracket.

In accordance with the present invention, the component of the exhaust system and the body of the motor vehicle can be secured to one another by a formfit via at least one safety device of the fastening structure.

The component of the exhaust system may be configured as muffler or rear muffler, which normally is to be secured via two times two mounting points to the body or to a bodyshell of the motor vehicle. Two of the mounting points are hereby arranged in travel direction, normally in forward travel direction, of the motor vehicle, and two of the mounting points are arranged at the rear of the component. The component is hereby floatingly arranged at the rear mounting points in longitudinal direction of the motor vehicle so that the component can be adjusted and/or appropriately aligned in horizontal direction during assembly.

When being installed, the fastening structure according to the present invention is arranged as additional assembly at one of the forward mounting points to ensure a formfitting connection at the bearing element, which is mounted directly to the vehicle body, and the component of the exhaust system. The nut of the fastening structure is threadably engaged to a thread of the fastening pin, after the fastening pin has been guided through the receiving hole of the safety device, thereby clamping at least one section of the safety device between the nut and the base plate of the bracket.

In the event, the pretension applied by the nut decreases as a result of a material offset or vibrations of both the exhaust system and the motor vehicle, the presence of the mechanical stop elements of the safety device prevents a detachment of the component from the body. Thus, the mechanical stop elements of the safety device realize an additional safety feature against mechanical damage cause by an offset of a mounting point between the body and the component. Even in the event, the nut and/or a corresponding bolted connection of the fastening structure seizes or detaches, the driver will notice such a weakening of the connection, since a loud rattling noise is caused. Still, the component of the exhaust system or parts of the motor vehicle will not be damaged.

According to still another aspect of the present invention, a method of securing a component of an exhaust system to a body of a motor vehicle includes securing a bracket to the component, securing a bearing element to the body, placing a fastening pin of the bracket in a recess of the bracket, attaching a safety device to the bracket by guiding the fastening pin of the bearing element through a receiving hole of the safety device, and arranging a mechanical stop element of the safety device in a receiving opening of the bracket.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic perspective view of one embodiment of an exhaust system according to the present invention;

FIG. 2 is a schematic perspective view of an example for a mounting point;

FIG. 3a is a schematic perspective view of a first variant of a safety device for a fastening structure according to the present invention;

FIG. 3b is a schematic perspective view of one embodiment of a fastening structure according to the present invention, equipped with the variant of the safety device of FIG. 3a;

FIG. 4a is a schematic perspective view of a second variant of a safety device for a fastening structure according to the present invention;

FIG. 4b is a schematic perspective view of another embodiment of a fastening structure according to the present invention, equipped with the variant of the safety device of FIG. 4a; and

FIG. 4c is a bottom view of the fastening structure of FIG. 4b.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

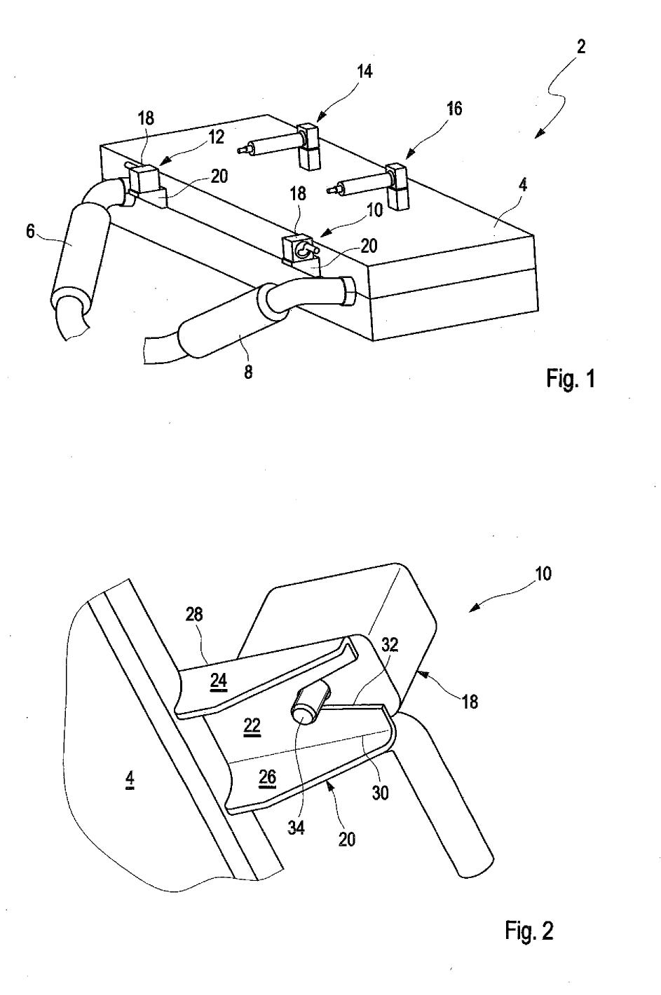

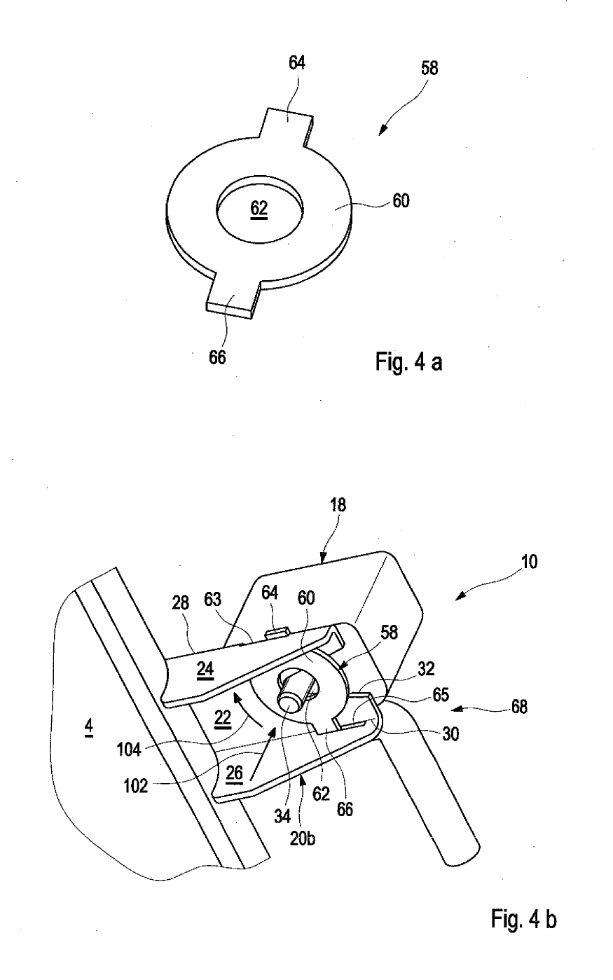

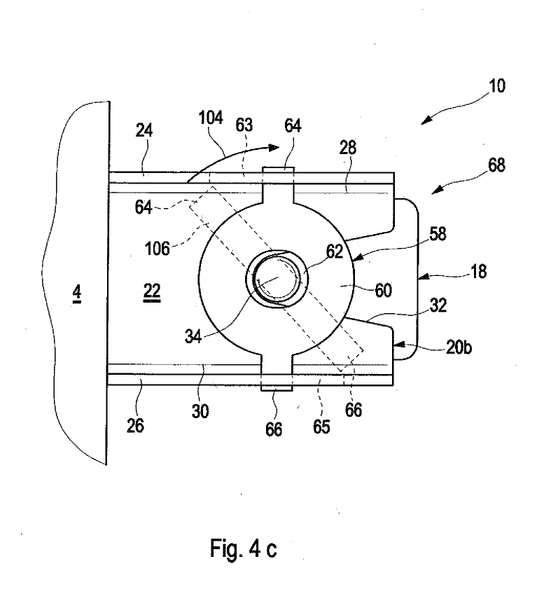

Turning now to the drawing, and in particular to FIG. 1, there is shown a schematic perspective view of one embodiment of an exhaust system according to the present invention, generally designated by reference numeral 2. The exhaust system 2 includes a muffler as a first component 4 and exhaust pipes as further components 6, 8. Two first mounting points 10, 12 and two second mounting points 14, 16 are shown in FIG. 1 by way of examples. FIGS. 3b and 4b show perspective views of two fastening structures 38, 68 which may be provided at the mounting points 10, 12 with their respective safety devices 36, 58, as shown in FIGS. 3a and 4b, respectively. Conversely, the mounting points 14, 16 are provided for a fastening structure with an eccentric via which the component 4 can be movably and floatingly arranged in relation to the body of the motor vehicle.

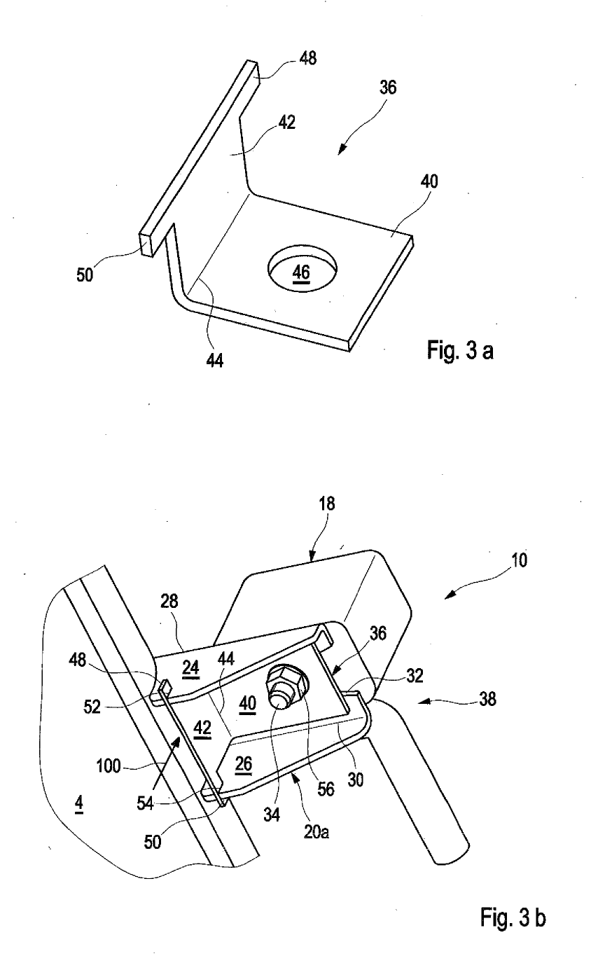

FIG. 2 shows by way of example a schematic perspective view of the mounting point 10, on an enlarged scale. The mounting point 10 includes a bearing element 18 in the form of a rubber bearing for firm securement to the body of the motor vehicle, and a bracket 20 for arrangement on the component 4 of the exhaust system 2.

The bearing element 18 has here by way of example a square configuration and may be made of a deformable material.

The bracket 20 includes a base plate 22 and two legs 24, 26 which may also be designated as wings. The base plate 22 is connected via a first bend 28 with the leg 24 and via a second bend 30 with the leg 26. Both legs 24, 26 extend parallel to one another and are oriented perpendicular to the base plate 20.

The base plate 22 further has a triangular recess 32 or opening which extends from an edge of the base plate 20 inwards. Each leg 24, 26 has a trapezoidal configuration, with a longest side of a leg 24, 26 extending along the respective bend 28, 30. A respective longer cross side, oriented here perpendicular to the bend 28, 30, is secured to the component 4. The bearing element 18 further includes a fastening pin 34 which is arranged by way of example on a tip of the recess 32 in the base plate 22 of the bracket 20.

FIG. 3a shows a schematic illustration of a first variant of a safety device, generally designated by reference numeral 36 and forming part of the fastening structure 38, as shown in FIG. 3b. Provision is hereby made for the fastening structure 38 to be also arranged at the first mounting point 10.

The safety device 36 includes a first flat rectangular portion 40 and a second flat rectangular portion 42 which are connected to one another via a bend 44 and arranged at an angle of about 90° to one another. The first portion 40 of the safety device 36 is formed in midsection with a receiving hole 46. An edge in parallel relation to the bend 44 at the end of the second portion 42 has a first mechanical stop element 48 and a second mechanical stop element 50 which form a prolongation of the edge of the second portion 42.

The fastening structure 38 includes in addition to the safety device 36 and the bearing element 18 a bracket 20a which differs from the bracket 20 of FIG. 2 by providing a receiving opening 52, 54 in each of the legs 24, 26.

The fastening structure 38 is installed, starting from the illustration of FIG. 2, by arranging the first portion 40 of the safety device 36 on the base plate 22 of the bracket 20a, with the fastening pin 34 being inserted into the receiving hole 46 of the first position 40. Arrow 100, as shown in FIG. 3b, indicates hereby a direction by which the safety device 36 is moved in relation to the bracket 20a.

Moreover, the first mechanical stop element 48 is arranged in a receiving opening 52 of the leg 24 of the bracket 20a. The second mechanical stop element 50 of the second portion 42 of the safety device 36 is arranged in a receiving opening 54 of the second portion 26 of the bracket 20a. A nut 56 or fastening nut is then threadably engaged to a thread of the fastening pin 34 to thereby clamp the first portion 40 of the safety device 36 between the nut 56 and the base plate 22 of the bracket 20a.

FIG. 4a shows a schematic perspective view of a second variant of a safety device, generally designated by reference numeral 58. The safety device 58 includes a flat disk 60 of substantially round perimeter and a receiving hole 62 in midsection of the disk 60. Mechanical stop elements 64, 66 are arranged on the disk 60 and have ends which are further distanced from a center of the disk 60 than any point on the otherwise round perimeter of the disk 60. A connecting line between the two mechanical stop elements 64, 66 extends also through the center of the disk 60.

The safety device 58 is part of the fastening structure 68 which is shown in FIG. 4b and has the bearing element 18 and a bracket 20b. A first receiving opening 63 in the form of a slot is arranged along the bend 28 between the base plate 22 and the leg 24 of the bracket 20b for receiving the stop element 64 of the safety device 58, after the fastening structure 68 has been installed. A second receiving opening 65, also in the form of a slot, is arranged along the bend 30 between the base plate 22 and the leg 26b of the bracket 20b for receiving the stop element 66 of the safety device 58.

As shown in FIGS. 4a and 4c, the installation of the fastening structure 68, starting from the illustration of FIG. 2, is as follows: The safety device 68 is arranged on the base plate 22 of the bracket 20b and the fastening pin 34 is guided or threaded through the receiving hole 62 of the safety device 58. This is shown by arrow 102 in FIG. 4b. A connecting line between the two mechanical stop elements 64, 66 is indicated in FIG. 4c in a first position of the safety device 58 by way of a dashed rectangle 106 and oriented in relation to a connecting line between the two receiving openings 63, 65 at an angle of 45°. From this first position, the safety device 58 is rotated clockwise about the fastening pin 34, as indicated in FIGS. 4b and 4c by curved arrow 104, so that the first mechanical stop element 63 in the form of a slot is turned along the bend 28 of the bracket 20b, and the second mechanical stop element 66, also in the form of a slot, is turned along the bend 30 of the bracket 20b.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A fastening structure for securing a component of an exhaust system to a body of a motor vehicle, said fastening structure comprising:
a bracket secured to the component of the exhaust system, said bracket including a recess and at least one receiving opening;
a bearing element secured to the body and configured for attachment to the bracket, said bearing element including a fastening pin received in the recess of the bracket; and
a safety device configured for attachment to the bracket, said safety device including a receiving hole for passage of the fastening pin of the bearing element, and at least one mechanical stop element configured for arrangement in the receiving opening of the bracket.

2. The fastening structure of claim 1, wherein the bracket includes a base plate and two legs extending in parallel relationship, said base plate extending between the legs in perpendicular relation thereto and connected to each of the legs via a bend, said recess being configured in the form of a triangular slot formed in the base plate.

3. The fastening structure of claim 1, wherein the safety device is configured in the form of a plate which is curved at the bend by 90° and includes two rectangular portions connected to one another by the bend, said receiving hole being formed in one of the portions, and said at least one mechanical stop element being arranged at an end of the other one of the portions.

4. The fastening structure of claim 3, wherein the safety device includes two of said mechanical stop element arranged at an edge of the other one of the two portions and oriented in opposite directions in parallel relation to the bend.

5. The fastening structure of claim 2, wherein the bracket has two of said receiving opening arranged in the legs of the bracket, respectively.

6. The fastening structure of claim 4, wherein the bracket has two of said receiving opening arranged in the legs of the bracket, respectively, said two mechanical stop elements being arranged in the receiving openings of the legs, respectively.

7. The fastening structure of claim 1, wherein the safety device is configured in the form of a flat disk, said receiving hole being arranged in midsection of the disk, said safety device including two of said mechanical stop element arranged at an outer edge of the disk and oriented in opposite directions.

8. The fastening structure of claim 2, wherein the receiving opening is formed in the bend between the base plate and the leg.

9. The fastening structure of claim 7, wherein the braked has two of said receiving opening, respectively arranged in the bends of the bracket, said safety device being configured for rotation about the fastening pin, after the fastening pin has been guided through the receiving hole and the safety device has been arranged on a base plate of the bracket, so as to turn the mechanical stop elements in the two receiving openings of the bracket, respectively.

10. The fastening structure of claim 1, further comprising a nut for treaded engagement upon the fastening pin, said safety device being clamped between the nut and the bracket.

11. An exhaust system, comprising:
a component; and
a fastening structure configured to secure the component to a body of a motor vehicle, said fastening structure comprising a bracket secured to the component and including a recess and at least one receiving opening, a bearing element secured to the body and configured for attachment to the bracket, said bearing element including a fastening pin received in the recess of the bracket, and a safety device configured for attachment to the bracket, said safety device including a receiving hole for passage of the fastening pin of the bearing element, and at least one mechanical stop element configured for arrangement in the receiving opening of the bracket.

12. A method of securing a component of an exhaust system to a body of a motor vehicle, comprising:
securing a bracket to the component;
securing a bearing element to the body;
placing a fastening pin of the bracket in a recess of the bracket;
attaching a safety device to the bracket by guiding the fastening pin of the bearing element through a receiving hole of the safety device; and
arranging a mechanical stop element of the safety device in a receiving opening of the bracket.

13. The method of claim 12, further comprising placing a base plate between two parallel legs in perpendicular relation thereto, connecting the base plate to each of the legs via a bend to thereby form the bracket, and forming the recess in the base plate in the form of a triangular slot.

14. The method of claim 12, further comprising:
bending a plate by 90° to form the safety device with two rectangular portions connected to one another by the bend,
forming the receiving hole in one of the portions, and
arranging the mechanical stop element at an end of the other one of the portions.

15. The method of claim 13, further comprising arranging two of said mechanical stop element at an edge of the other one of the two portions at an orientation in opposite directions and in parallel relation to the bend.

16. The method of claim 13, further comprising arranging a said receiving opening in each of the legs of the bracket.

17. The method of claim 16, further comprising arranging in each of the receiving openings of the legs a said mechanical stop element.

18. The method of claim 12, further comprising forming the receiving hole in midsection of a flat disk to form the safety device, and arranging two of said mechanical stop element of the safety device at an outer edge of the disk at an orientation in opposite directions.

19. The method of claim 13, further comprising forming the receiving opening in the bend between the base plate and the leg.

20. The method of claim 18, further comprising rotating the safety device to thereby respectively turn the mechanical stop elements in the receiving openings of the bracket.

21. The method of claim 12, further comprising threadably engaging a nut upon the fastening pin to thereby clamp the safety device between the nut and the bracket.
